(19) United States
(12) Patent Application Publication
(10) Pub. No.: US 2025/0033485 A1
(43) Pub. Date: Jan. 30, 2025

(54) BRAKE SYSTEM AND CONTROL METHOD THEREOF

(71) Applicant: HL MANDO CORPORATION, Pyeongtaek (KR)

(72) Inventors: Sihun LEE, Seongnam (KR); Jaehoon Jang, Seoul (KR)

(21) Appl. No.: 18/518,490

(22) Filed: Nov. 23, 2023

(30) Foreign Application Priority Data
Jul. 24, 2023 (KR) 10-2023-0096147

(51) Int. Cl. B60L 7/26; B60T 8/171; B60T 8/1761; B60T 13/74

(52) U.S. Cl. CPC B60L 7/26; B60T 8/171; B60T 8/1761; B60T 13/741; B60L 2240/421; B60L 2240/423; B60L 2240/429; B60L 2240/465; B60L 2250/26; B60T 2220/04; B60T 2270/10

(57) ABSTRACT

A brake system may include: an electro mechanical brake provided with a motor and configured to brake a wheel of a vehicle based on a driving control of the motor; and a first controller configured to control the electro mechanical brake to provide current for reverse driving torque to the motor, based on a torque value of the motor at a time at which the motor starts being driven in a brake release direction according to a signal for operating an anti-lock brake system of the vehicle.

### CROSS-REFERENCE TO RELATED APPLICATION(S)

This application is based on and claims priority under 35 U.S.C. § 119 to Korean Patent Application No. 10-2023-0096147, filed on Jul. 24, 2023, in the Korean Intellectual Property Office, the disclosure of which is incorporated by reference herein in its entirety.

### BACKGROUND

### 1. Field

The disclosure relates to a brake system and a control method thereof.

### 2. Description of the Related Art

An Electro Mechanical Brake (EMB) of a brake system generates a braking force of a vehicle by driving a motor, unlike a hydraulic control method of a typical hydraulic brake.

When the motor of the electro mechanical brake starts rotating in the opposite direction of its current driving direction during driving, an inertial force and torque ripples generate in the previous driving direction.

Accordingly, the electro mechanical brake has had a problem that the decompression response slows down. Also, as the decompression response of the electro mechanical brake slows down, the electro mechanical brake has deteriorated the operation performance of the Anti-lock Brake System (ABS) of the vehicle, compared to the hydraulic brake.

### SUMMARY

It is an aspect of the disclosure to provide a brake system capable of controlling a decompression amount of an electro mechanical brake to a desired amount while improving a decompression response compared to a typical electro mechanical brake, and a method for controlling the brake system.

It is an aspect of the disclosure to provide a brake system capable of preventing operation performance deterioration of a typical Anti-lock Brake System (ABS) by improving a decompression response of an electro mechanical brake, and a method for controlling the brake system.

Additional aspects of the disclosure will be set forth in part in the description which follows and, in part, will be obvious from the description, or may be learned by practice of the disclosure.

A brake system according to an aspect of the disclosure may include: an electro mechanical brake provided with a motor and configured to brake a wheel of a vehicle based on a driving control of the motor; and a first controller configured to control the electro mechanical brake to provide current for reverse driving torque to the motor, based on a torque value of the motor at a time at which the motor starts being driven in a brake release direction according to a signal for operating an anti-lock brake system of the vehicle.

The brake system may further include a memory storing a plurality of preset reference torque values at the time at which the motor starts being driven in the brake release direction and current values for target reverse driving torque respectively corresponding to the plurality of preset reference torque values, wherein the first controller may be configured to identify a reference torque value corresponding to the torque value of the motor at the time at which the motor starts being driven in the brake release direction from among the plurality of preset reference torque values, and determine a current value for target reverse driving torque corresponding to the identified reference torque value as a current value of the current for reverse driving torque.

The first controller may be configured to stop providing the current for reverse driving torque to the motor, according to a speed of the motor reaching a preset target speed while the current for reverse driving torque is provided to the motor.

The brake system may further include a second controller configured to generate a signal for operating the anti-lock brake system based on occurrence of wheel slip of the vehicle.

The second controller may be configured to identify occurrence of wheel slip of the vehicle based on an output signal from a wheel speed sensor of the vehicle, while a force is applied to a brake pedal of the vehicle.

The second controller may be configured to identify that a force is applied to the brake pedal, according to reception of an output signal from a pedal sensor configured to detect a displacement of the brake pedal.

The second controller may be configured to control the first controller to provide current for driving torque to the motor by providing the first controller with a pressure force of the electro mechanical brake according to an output signal from the pedal sensor, while no wheel slip of the vehicle occurs.

A brake system according to an aspect of the disclosure may include: an electro mechanical brake provided with a motor and configured to brake a wheel of a vehicle based on a driving control of the motor; and a first controller configured to control the electro mechanical brake to provide current for reverse driving torque to the motor, until a speed of the motor reaches a preset target speed from a time at which the motor starts being driven in a brake release direction, based on conversion of an operation mode of the vehicle into an anti-lock brake system operation mode.

The brake system may further include a memory storing a plurality of preset reference torque values at the time at which the motor starts being driven in the brake release direction and current values for target reverse driving torque respectively corresponding to the plurality of preset reference torque values, wherein the first controller may be configured to identify a reference torque value corresponding to a torque value of the motor at the time at which the motor starts being driven in the brake release direction from among the plurality of preset reference torque values, and determine a current value for target reverse driving torque corresponding to the identified reference torque value as a current value of the current for reverse driving torque.

The brake system may further include a second controller configured to convert the operation mode of the vehicle into the anti-lock brake system operation mode based on occurrence of wheel slip of the vehicle.

The second controller may be configured to identify occurrence of wheel slip of the vehicle, based on an output signal from a wheel speed sensor of the vehicle, while a force is applied to a brake pedal of the vehicle.

The second controller may be configured to identify that a force is applied to the brake pedal, according to reception of an output signal from a pedal sensor configured to detect a displacement of the brake pedal.

The second controller may be configured to control the first controller to provide current for driving torque to the motor by providing the first controller with a pressure force of the electro mechanical brake according to the output signal from the pedal sensor, while no wheel slip of the vehicle occurs.

A method for controlling a brake system according to an aspect of the disclosure may include: detecting a signal for operating an anti-lock brake system of a vehicle; and controlling an electro mechanical brake to provide current for reverse driving torque to a motor, based on a torque value of the motor at a time at which the motor starts being driven in a brake release direction, according to the signal for operating the anti-lock brake system.

The method may further include: storing a plurality of preset reference torque values at the time at which the motor starts being driven in the brake release direction and current values for target reverse driving torque respectively corresponding to the plurality of preset reference torque values; identifying a reference torque value corresponding to the torque value of the motor at the time at which the motor starts being driven in the brake release direction from among the plurality of preset reference torque values; and determining a current value for target reverse driving torque corresponding to the identified reference torque value as a current value of the current for reverse driving torque.

The method may further include controlling the electro mechanical brake to stop providing the current for reverse driving torque to the motor, according to a speed of the motor reaching a preset target speed while the current for reverse driving torque is provided to the motor.

The signal for operating the anti-lock brake system may be generated based on occurrence of wheel slip of the vehicle.

The method may further include identifying occurrence of wheel slip of the vehicle based on an output signal from a wheel speed sensor of the vehicle, while a force is applied to a brake pedal of the vehicle.

The method may include identifying that a force is applied to the brake pedal according to reception of an output signal from a pedal sensor configured to detect a displacement of the brake pedal.

The method may further include the electro mechanical brake to provide current for driving torque to the motor based on a braking force according to an output signal from the pedal sensor, while no wheel slip of the vehicle occurs.

### BRIEF DESCRIPTION OF THE DRAWINGS

These and/or other aspects of the disclosure will become apparent and more readily appreciated from the following description of the embodiments, taken in conjunction with the accompanying drawings of which:

FIG. 1 is a block diagram of a vehicle including an electro mechanical brake according to an embodiment;

FIG. 2 is a flowchart illustrating an operation of a brake system according to an embodiment;

FIG. 3 is a flowchart illustrating an operation of a brake system according to an embodiment;

FIGS. 4A and 4B briefly shows graphs for describing an operation of a brake system according to an embodiment of the disclosure in comparison with an operation of a typical brake system; and

FIGS. 5A and B shows graphs for describing an operation of a brake system according to an embodiment of the disclosure in comparison with an operation of a typical brake system.

### DETAILED DESCRIPTION

Like reference numerals refer to like components throughout the specification. This specification does not describe all the components of the embodiments, and duplicative contents between embodiments or general contents in the technical field of the present disclosure will be omitted. The terms ‘part,’ ‘module,’ ‘member,’ and ‘block’ used in this specification may be embodied as software or hardware, and it is also possible for a plurality of ‘parts,’ ‘modules,’ ‘members,’ and ‘blocks’ to be embodied as one component, or one ‘part,’ ‘module,’ ‘member,’ and ‘block’ to include a plurality of components according to embodiments.

Throughout the specification, when a part is referred to as being ‘connected’ to another part, it includes not only a direct connection but also an indirect connection, and the indirect connection includes connecting through a wireless network.

Also, when it is described that a part ‘includes’ a component, it means that the part may further include other components, not excluding the other components unless specifically stated otherwise.

Throughout the specification, when a member is described as being ‘on’ another member, this includes not only a case in which the member is in contact with the other member but also a case in which another member is present between the two members.

The terms first, second, etc. are used to distinguish one component from another component, and the components are not limited by the above-mentioned terms.

The singular forms ‘a,’ ‘an,’ and ‘the’ include plural referents unless the context clearly dictates otherwise.

In each operation, an identification numeral is used for convenience of explanation, the identification numeral does not describe the order of the operations, and each operation may be performed differently from the order specified unless the context clearly states a particular order.

Hereinafter, an operation principle and embodiments of the disclosure will be described with reference to the accompanying drawings.

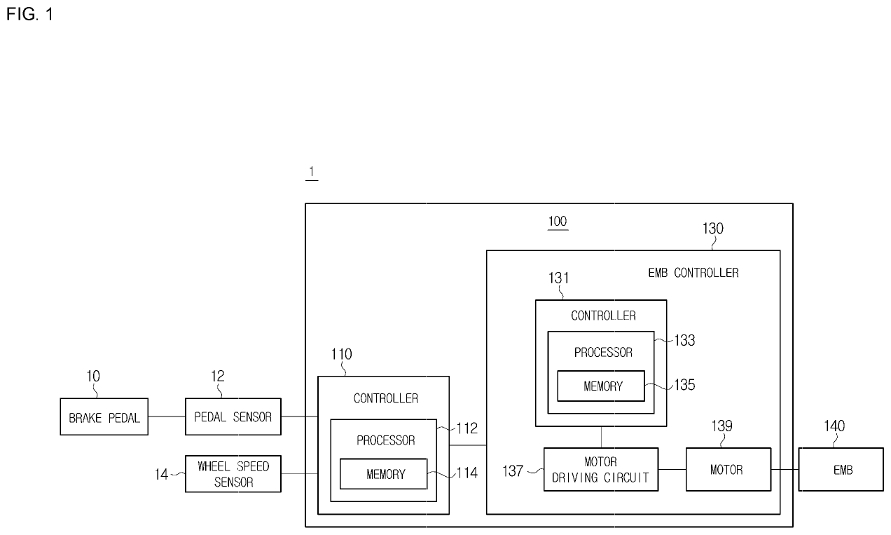

FIG. 1 is a block diagram of a vehicle including an electro mechanical brake according to an embodiment.

Referring to FIG. 1, a vehicle 1 may include a brake pedal 10, a pedal sensor 12, a wheel speed sensor 14, and/or a brake system 100.

The brake pedal 10 may obtain a driver's input for braking the vehicle 1.

For example, the brake pedal 10 may be provided in a lower area of a cabin to enable a driver to control the brake pedal 10 with his/her foot. The driver may step on the brake pedal 10 as a braking intention to brake the vehicle 1, and accordingly, the brake pedal 10 may depart from a reference position and move.

The pedal sensor 12 may detect a displacement (or obtain displacement information) of the brake pedal 10.

For example, the pedal sensor 12 may be physically connected to the brake pedal 10 to measure a movement of the brake pedal 10. The pedal sensor 12 may detect a movement distance from the reference position of the brake pedal 10 and/or a movement speed of the brake pedal 10.

The pedal sensor 12 may be electrically connected to the brake system 100, and provide an electrical signal to the brake system 100.

For example, the pedal sensor 12 may be directly connected to the brake system 100 through a hard wire or may be connected to the brake system 100 through a communication network. The pedal sensor 12 may provide an electrical signal corresponding to a movement distance and/or a movement speed of the brake pedal 10 to the brake system 100. Also, the pedal sensor 12 may be integrated into the brake system 100.

The wheel speed sensor 14 may detect a speed (also, referred to as revolutions per minute (rpm)) of wheels of the vehicle 1. The wheel speed sensor 14 may include a plurality of wheel speed sensors respectively installed in the wheels of the vehicle 1. The plurality of wheel speed sensors may independently detect speeds of the corresponding wheels.

The wheel speed sensor 14 may be electrically connected to the brake system 100, and provide an electrical signal to the brake system 100.

For example, each of the plurality of wheel speed sensors may be directly connected to the brake system 100 through a hard wire or may be connected to the brake system 100 through a communication network. Each of the plurality of wheel speed sensors may provide an electrical signal corresponding to rpm of the corresponding wheel to the brake system 100.

The brake system 100 may include a controller 110, an Electro Mechanical Brake (EMB) controller 130, and/or an electro mechanical brake 140.

The controller 110 may receive an output signal from the pedal sensor 12 and/or the wheel speed sensor 14, and provide a control signal to the EMB controller 130 based on the output signal from the pedal sensor 12 and/or the wheel speed sensor 14.

The controller 110 may also be referred to as a Brake Control Unit (BCU) (or referred to as a second controller), and include an Electronic Control Unit (ECU).

The controller 110 may include a processor 112.

The processor 112 may process the output signal from the pedal sensor 12 and/or the wheel speed sensor 14, and convert an operation mode of the vehicle 1 into an anti-lock brake system operation mode to reduce wheel slip of the vehicle 1 based on the output signal.

Also, the processor 112 may generate a signal for operating an anti-lock brake system of the vehicle 1, and provide the signal to the EMB controller 130.

While the processor 112 maintains an appropriate wheel slip amount of the vehicle 1 in the anti-lock brake system operation mode, the processor 112 may provide a brake apply signal and a brake release signal in a form of a force (unit: N) to the EMB controller 130.

The processor 112 may include a memory 114 that stores or memorizes a program and data for implementing operations of controlling components included in the brake system 100.

The memory 114 may provide the stored program and data to the processor 112, and memorize temporary data generated while the processor 112 operates.

For example, the memory 114 may include a volatile memory, such as Static Random Access Memory (S-RAM) and Dynamic Random Access Memory (D-RAM), and a non-volatile memory, such as Read Only Memory (ROM), Erasable Programmable Read Only Memory (EPROM), Electrically erasable Programmable Read Only Memory (EEPROM), and flash memory.

The EBM controller 130 may provide a braking force to the vehicle 1, that is, to the wheels of the vehicle 1, or reduce a braking force applied to the wheels of the vehicle 1, based on reception of a signal for controlling braking of the vehicle 1 or a signal for releasing braking of the vehicle 1 from the controller 110.

The EMB controller 130 may include a controller 131 (or referred to as a first controller), a motor driving circuit 137, and a motor 139.

The controller 131 may control the motor driving circuit 137 based on reception of a signal from the controller 110.

For example, the controller 131 may receive a pressure force of the electro mechanical brake 140 from the controller 110, and convert the pressure force of the electro mechanical brake 140 into a torque of the motor 139 to drive the motor 139. The controller 131 may apply a Pulse Width Modulation (PWM) voltage for motor driving to the motor driving circuit 137 to provide current to the motor 139.

The controller 131 may include a processor 133, and the processor 133 may include a memory 135 that stores or memorizes a program and data for implementing operations of controlling components included in the EMB controller 130.

The processor 133 may control the electro mechanical brake 140 based on a signal (for example, an anti-lock brake system mode flag and a braking release signal) for operating the anti-lock brake system of the vehicle 1 through the electro mechanical brake 140.

The processor 133 may provide current for reverse driving torque to the motor 139, based on a torque value of the motor 139 at a time at which the motor 139 of the EMB controller 130 starts being driven in a brake release direction in response to the signal for operating the anti-lock brake system of the vehicle 1.

For example, the processor 133 may perform a control of providing current for reverse driving torque to the motor 139 until a speed of the motor 139 reaches a preset target speed from the time at which the motor 139 starts being driven in the brake release direction, based on conversion of the operation mode of the vehicle 1 into the anti-lock brake system operation mode.

For example, a plurality of preset reference torque values at a time at which the motor 139 of the EMB controller 130 starts being driven in the brake release direction and current values for target reverse driving torque respectively corresponding to the plurality of preset reference torque values may be stored in the memory 135.

The motor driving circuit 137 may control driving current that is supplied to the motor 139, according to a motor control signal from the controller 131.

For example, the motor driving circuit 137 may include a three-phase inverter including a plurality of switching devices for controlling driving current that is supplied to the motor 139, and an inverter driver for controlling the switching devices included in the three-phase inverter according to a motor control signal from the controller 131. The inverter driver may provide a motor driving signal for driving the three-phase inverter to the switching devices of the three-phase inverter according to a motor control signal from the controller 131. The three-phase inverter may convert direct current power supplied from a battery of the vehicle 1 into alternating current power according to a motor driving signal from the inverter driver, and provide the converted alternating current power to the motor 139.

The motor 139 may generate a rotational force by receiving the driving current from the motor driving circuit 137.

For example, the motor 139 may be a Direct Current (DC) motor or a three-phase motor (for example, a Brushless Direct Current (BLDC) motor, a Brushless Alternating Current (BLAC) motor, or a Permanent Magnet Synchronous Motor (PMSM)).

For example, the EMB controller 130 may be a caliper brake.

Accordingly, the electro mechanical brake 140 may include, for each wheel, a disc (not shown) that rotates together with the corresponding wheel, a brake pad (not shown) installed to press the disc, a caliper housing (not shown) for operating the brake pad, a piston (not shown) that moves back and forth inside the caliper housing, and a power conversion unit (not shown) for converting a rotation driving force generated by the motor 139 into a linear driving force and transferring the linear driving force to the piston to move the piston, although not shown.

Meanwhile, although the controller 110 and the EMB controller 130 have been described as separate components in the embodiment of FIG. 1, the controller 110 and the EMB controller 130 may be implemented as a single controller according to another embodiment.

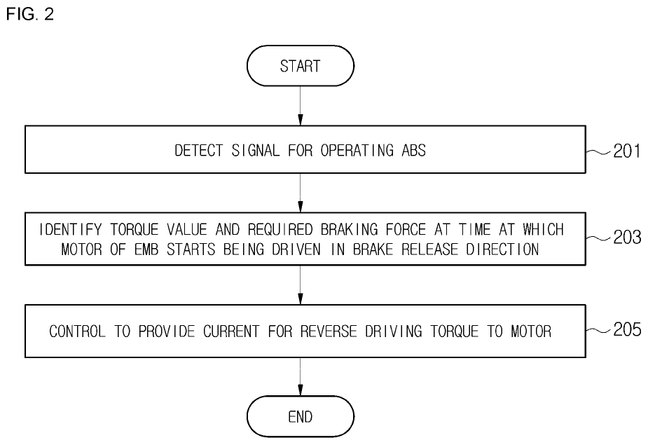

FIG. 2 is a flowchart illustrating an operation of the brake system 100 according to an embodiment.

Referring to FIG. 2, the brake system 100 (or the controller 110 and/or the processor 112) may detect a signal for operating the anti-lock brake system (201).

The brake system 100 may generate the signal for operating the anti-lock brake system based on occurrence of wheel slip of the vehicle 1.

For example, the brake system 100 may identify that a force is applied to the brake pedal 10, according to reception of an output signal from the pedal sensor 12 that detects a displacement of the brake pedal 10. Also, while a force is applied to the brake pedal 10, the brake system 100 may identify occurrence of wheel slip of the vehicle 1, based on an output signal from the wheel speed sensor 14 of the vehicle 1.

The brake system 100 (and/or the controller 131 and/or the processor 133) may identify a torque value and a required braking force at a time at which the motor 139 of the electro mechanical brake 140 starts being driven in the brake release direction, according to the signal for operating the anti-lock brake system (203).

The brake system 100 (and/or the controller 131 and/or the processor 133) may control the motor driving circuit 137 to provide current for reverse driving torque to the motor 139 based on the identified torque value and required braking force (205).

The current for reverse driving torque may be provided to the motor 139 of the EMB controller 130 at the time at which the motor 139 starts being driven in the brake release direction.

For example, a plurality of preset reference torque values at the time at which the motor 139 starts being driven in the brake release direction and current values for target reverse driving torque respectively corresponding to the plurality of preset reference torque values may have been stored in advance in the memory 114.

The brake system 100 may identify a reference torque value corresponding to (or included in) the torque value of the motor 139 at the time at which the motor 139 starts being driven in the brake release direction, from among the plurality of preset reference torque values stored in the memory 114.

Because an existing inertial force needs to be calibrated upon decompression of the brake pad, a boost torque Boost Tq may be instantaneously required, and the boost torque Boost Tq may be the torque value of the motor 139 at the time at which the motor 139 starts being driven in the brake release direction.

Because the higher pressure applied to the brake pad requires the greater force to be applied in the brake release direction, the torque value of the motor 139 at the time at which the motor 139 starts being driven in the brake release direction may be determined based on a target pressure amount (Skid pressure) immediately before release in a braking cycle of the anti-lock brake system.

The brake system 100 may determine a current value for target reverse driving torque corresponding to the identified reference torque value, as a current value for reverse driving torque, and control the motor driving circuit 137 to provide the current value for reverse driving torque to the motor 139.

When a speed (rad/s) (or speed (mm/s) of the piston) of the motor 139 reaches a preset target speed while the current for reverse driving torque is provided to the motor 139, the brake system 100 may control the EMB controller 130 to stop providing the current for reverse driving torque to the motor 139.

Meanwhile, in the above-described embodiment, while no wheel slip of the vehicle 1 occurs, the brake system 100 may control the EMB controller 130 to provide current for driving torque to the motor 139 based on a braking force according to an output signal from the pedal sensor 12.

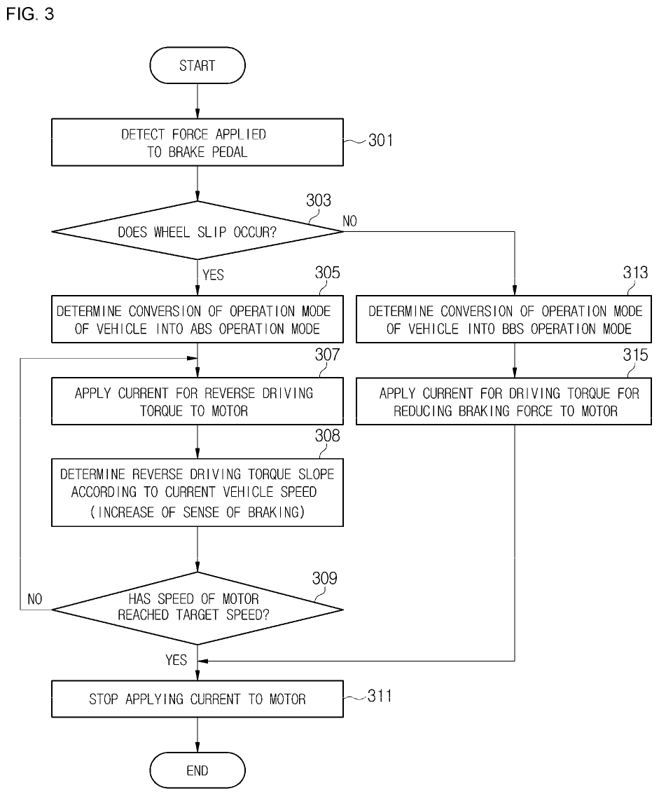

FIG. 3 is a flowchart illustrating an operation of the brake system 100 according to an embodiment.

Referring to FIG. 3, the brake system 100 (and/or the controller 110 and/or the processor 112) may detect a force applied to the brake pedal 10 (301).

The brake system 100 may detect the force applied to the brake pedal 10 based on an output signal from the pedal sensor 10.

The brake system 100 (and/or the controller 110 and/or the processor 112) may identify occurrence of wheel slip of the vehicle 1 while the force is applied to the brake pedal 10 (303).

The brake system 100 may identify occurrence of wheel slip of the vehicle 1 based on a wheel speed, a vehicle speed, and a vehicle deceleration.

The brake system 100 may perform operation 305 upon occurrence of wheel slip of the vehicle 1, and otherwise, the brake system 100 may perform operation 313.

The brake system 100 (and/or the controller 110 and/or the processor 112) may determine conversion of an operation mode of the vehicle 1 into an anti-lock brake system operation mode (305).

The brake system 100 (and/or the controller 110 and/or the processor 112) may control the motor driving circuit 137 to apply current for reverse driving torque to the motor 139, based on the determining of the conversion of the operation mode of the vehicle 1 into the anti-lock brake system operation mode (307).

The brake system 100 may generate a signal for rotating the motor 139 in a reverse direction to reduce a braking force in an initial cycle of the anti-lock brake system operation mode, according to the determining of the conversion into the anti-lock brake system operation mode.

Accordingly, the brake system 100 may control the EMB controller 130 to apply, to the motor 139, current for reverse driving torque capable of removing a current inertial force and torque ripples of the motor 139 for a preset time.

For example, the current for reverse driving torque may be provided to the motor 139 at the time at which the motor 139 starts being driven in the brake release direction.

The current for reverse driving torque may be determined based on the plurality of preset reference torque values at the time at which the motor 139 starts being driven in the brake release direction and the current values for target reverse driving torque respectively corresponding to the plurality of preset reference torque values, stored in the memory 135.

The brake system 100 may identify a reference torque value corresponding to a torque value of the motor 139 at the time at which the motor 139 starts being driven in the brake release direction, from among the plurality of preset reference torque values stored in the memory 135. Also, the brake system 100 may determine a current value for target reverse driving torque corresponding to the identified reference torque value as a current value of the current for reverse driving torque.

The brake system 100 (and/or the controller 110 and/or the processor 112) may determine a reverse driving torque slope according to a current speed of the vehicle 1 to increase a sense of braking (308).

Because an amount of current for reverse driving torque is determined based on pressure currently applied to the brake pad, it may be necessary to determine how fast to apply the current for reverse driving torque upon application of the current for reverse driving torque to the motor 139.

To improve a sense of braking of the vehicle 1, it may be necessary to determine how stably and smoothly the motor 139 will reach a preset target speed which will be described below, and to this end, the brake system 100 may need to determine a reverse driving torque slope and ramp down the reverse driving torque slope.

The brake system 100 (and/or the controller 110 and/or the processor 112) may identify whether a speed of the motor 139 has reached the preset target speed while the current for reverse driving torque is applied to the motor 139 (309).

When the speed of the motor 139 has reached the preset target speed, the brake system 100 may perform operation 311, and, otherwise, the brake system 100 may continue to perform operation 307.

For example, the brake system 100 may perform operation 311 or operation 307 by further considering wheel slip and/or a deceleration in addition to the speed of the motor 139.

The brake system 100 (and/or the controller 110 and/or the processor 112) may control the motor driving circuit 137 to stop applying the current to the motor 139 (311).

When the speed of the motor 139 has reached the preset target speed, it may be considered that the inertial force (and/or torque ripples) has been removed. Accordingly, the brake system 100 may no longer apply the current for reverse driving torque that is applied to the motor 139 to remove the inertial force.

Meanwhile, when the speed of the motor 139 has not reached the preset target speed, the brake system 100 may continue to apply the current for reverse driving torque to the motor 139 to remove the inertial force.

The brake system 100 (and/or the controller 110 and/or the processor 112) may determine conversion of an operation mode of the vehicle 1 into a Base Brake System (BBS) operation mode, according to the above-described operation 303 (313).

The brake system 100 (and/or the controller 110 and/or the processor 112) may control the motor driving circuit 137 to apply current for driving torque for reducing a braking force to the motor 139, based on the determining of the conversion of the operation mode of the vehicle 1 into the BBS operation mode (315).

The brake system 100 may control the motor driving circuit 137 by determining current for driving torque for reducing a braking force for the motor 139, based on an output signal from the pedal sensor 12 of the brake pedal 10.

The brake system 100 may perform the above-described operation 311 after performing operation 315.

According to the above-described embodiment, while a driver presses the brake pedal 10 to brake the vehicle 1, the brake system 100 may detect occurrence of wheel slip of the vehicle 1 and determine whether to convert the operation mode of the vehicle 1 into the anti-lock brake system operation mode.

Also, the brake system 100 may provide the motor 139 with current for reverse driving torque capable of removing an inertial force (and/or torque ripples) generated in the previous rotation direction of the motor 139, while reducing a braking force generated by pressure applied to the brake pedal 10 according to the conversion of the operation mode of the vehicle 1 into the anti-lock brake system operation mode.

By providing the motor 139 with the current for reverse driving torque, a problem that a decompression response of a braking force slows down by an inertial force (and/or torque ripples) of the motor 139 may be solved.

For example, the brake system 100 may generate an anti-lock brake system operation mode flag and a brake release signal according to the determining of the conversion of the operation mode of the vehicle 1 into the anti-lock brake system operation mode.

The brake system 100 may determine a torque value of the motor 139 according to a clamping force in a brake release direction for reducing a braking force.

The brake system 100 may provide current for reverse torque to the motor 139 at a time at which the anti-lock brake system starts operating, that is, at a time at which the motor 139 starts being driven in the brake release direction, based on the generation of the anti-lock brake system operation mode flag and the determining of the torque value of the motor 139.

By instantaneously applying reverse current for removing an inertial force of the motor 139 for a specific time, the brake system 100 may prevent wheel lock of the vehicle 1, and minimize wheel vibrations of the vehicle 1 while the anti-lock brake system operation mode operates, thereby improving a sense of braking of the vehicle 1.

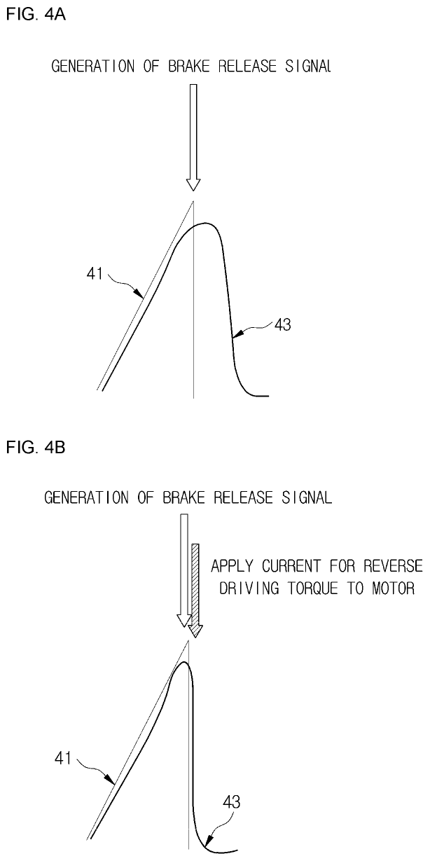

FIGS. 4A and 4B briefly shows graphs for describing an operation of a brake system according to an embodiment of the disclosure in comparison with an operation of a typical brake system, wherein a horizontal axis represents time and a vertical axis represents torque values.

FIG. 4A is a graph for comparing a change of a torque value of a motor according to an operation of the typical brake system with a change of a target torque value for target braking. FIG. 4B is a graph for comparing a change of a torque value of the motor 139 according to an operation of the brake system 100 according to an embodiment of the disclosure with a change of a target torque value for target braking.

Referring to FIG. 4A, when a brake release signal is generated according to occurrence of wheel slip, a target torque value for target braking is reduced sharply, whereas a torque value of a motor of an actual typical electro mechanical brake is reduced after a preset time elapses due to an inertial force and/or torque ripples of the motor. Accordingly, typically, there has been a problem that a decompression response of a braking force slows down.

Meanwhile, referring to FIG. 4B, by applying current for reverse driving torque to the motor 139 upon generation of a brake release signal according to occurrence of wheel slip, a torque value of the motor 139 may be reduced similar to the target torque value for target braking being reduced sharply.

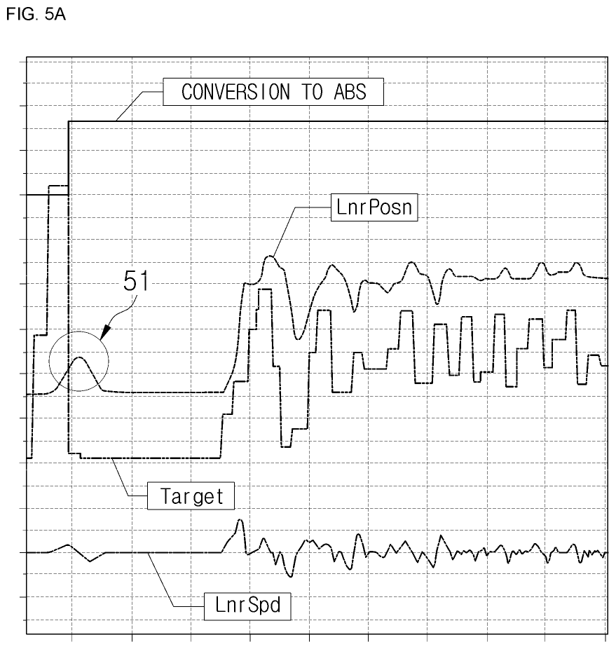

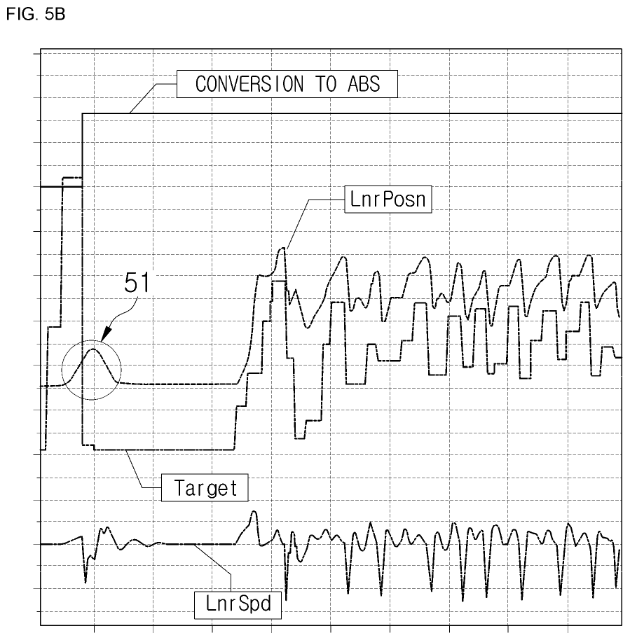

FIGS. 5A and 5B shows graphs for describing an operation of a brake system according to an embodiment of the disclosure in comparison with an operation of a typical brake system.

Referring to FIG. 5A, a graph representing changes of a speed LnrSpd of a motor, an actual position LnrPosn of a piston, and/or a target position Target of the piston upon conversion of the operation mode of a vehicle into the anti-lock brake system operation mode, according to an operation of the typical brake system is shown.

Referring to FIG. 5B, a graph representing changes of a speed LnrSpd of the motor 139, an actual position LnrPosn of the piston, and/or a target position Target of the piston upon conversion of the operation mode of the vehicle 1 into the anti-lock brake system operation mode, according to an operation of the brake system 100 according to an embodiment of the disclosure is shown.

Referring to FIG. 5A, it is seen that upon the conversion into the anti-lock brake system operation mode, typically, a difference 51 is made between the target position Target of the piston and the actual position LnrPosn of the piston.

Meanwhile, referring to FIG. 5B, it is seen that upon the conversion into the anti-lock brake system operation mode, the actual position LnrPosn of the piston changes similar to the target position Target of the piston.

The brake system and the control method thereof according to the above-described embodiments may improve response performance upon a control of the anti-lock brake system of the vehicle through improvement of a decompression response of the electro mechanical brake.

For example, the brake system and the control method thereof according to an aspect of the disclosure may improve a response of the anti-lock brake system of the vehicle to an equal or superior level to that of the hydraulic brake system.

Meanwhile, the disclosed embodiments may be implemented in the form of a recording medium that stores instructions executable by a computer. The instructions may be stored in the form of program codes, and when executed by a processor, the instructions may perform operations of the disclosed embodiments by generating a program module. The recording medium may be implemented as a computer-readable recording medium.

The computer-readable recording medium may include all kinds of recording media storing instructions that can be interpreted by a computer. For example, the computer-readable recording medium may be Read Only Memory (ROM), Random Access Memory (RAM), a magnetic tape, a magnetic disc, flash memory, an optical data storage device, etc.

A machine-readable storage medium may be provided in the form of a non-transitory storage medium, wherein the term ‘non-transitory’ simply means that the storage medium is a tangible device, and does not include a signal (e.g., an electromagnetic wave), but this term does not differentiate between where data is semi-permanently stored in the storage medium and where the data is temporarily stored in the storage medium.

So far, the disclosed embodiments have been described with reference to the accompanying drawings. It will be understood by one of ordinary skill in the technical art to which the disclosure belongs that the disclosure can be embodied in different forms from the disclosed embodiments without changing the technical spirit and essential features of the disclosure. Thus, it should be understood that the disclosed embodiments described above are merely for illustrative purposes and not for limitation purposes in all aspects.

What is claimed is:

1. A brake system comprising:
an electro mechanical brake provided with a motor and configured to brake a wheel of a vehicle based on a driving control of the motor; and
a first controller configured to control the electro mechanical brake to provide current for reverse driving torque to the motor, based on a torque value of the motor at a time at which the motor starts being driven in a brake release direction according to a signal for operating an anti-lock brake system of the vehicle.

2. The brake system of claim 1, further comprising a memory storing a plurality of preset reference torque values at the time at which the motor starts being driven in the brake release direction and current values for target reverse driving torque respectively corresponding to the plurality of preset reference torque values,
wherein the first controller is configured to identify a reference torque value corresponding to the torque value of the motor at the time at which the motor starts being driven in the brake release direction from among the plurality of preset reference torque values, and determine a current value for target reverse driving torque corresponding to the identified reference torque value as a current value of the current for reverse driving torque.

3. The brake system of claim 1, wherein the first controller is configured to stop providing the current for reverse driving torque to the motor, according to a speed of the motor reaching a preset target speed while the current for reverse driving torque is provided to the motor.

4. The brake system of claim 1, further comprising a second controller configured to generate a signal for operating the anti-lock brake system based on occurrence of wheel slip of the vehicle.

5. The brake system of claim 4, wherein the second controller is configured to identify occurrence of wheel slip of the vehicle based on an output signal from a wheel speed sensor of the vehicle, while a force is applied to a brake pedal of the vehicle.

6. The brake system of claim 5, wherein the second controller is configured to identify that a force is applied to the brake pedal, according to reception of an output signal from a pedal sensor configured to detect a displacement of the brake pedal.

7. The brake system of claim 6, wherein the second controller is configured to control the first controller to provide current for driving torque to the motor by providing the first controller with a pressure force of the electro mechanical brake according to an output signal from the pedal sensor, while no wheel slip of the vehicle occurs.

8. A brake system comprising:
an electro mechanical brake provided with a motor and configured to brake a wheel of a vehicle based on a driving control of the motor; and
a first controller configured to control the electro mechanical brake to provide current for reverse driving torque to the motor, until a speed of the motor reaches a preset target speed from a time at which the motor starts being driven in a brake release direction, based on conversion of an operation mode of the vehicle into an anti-lock brake system operation mode.

9. The brake system of claim 8, further comprising a memory storing a plurality of preset reference torque values at the time at which the motor starts being driven in the brake release direction and current values for target reverse driving torque respectively corresponding to the plurality of preset reference torque values,
wherein the first controller is configured to identify a reference torque value corresponding to a torque value of the motor at the time at which the motor starts being driven in the brake release direction from among the plurality of preset reference torque values, and determine a current value for target reverse driving torque corresponding to the identified reference torque value as a current value of the current for reverse driving torque.

10. The brake system of claim 8, further comprising a second controller configured to convert the operation mode of the vehicle into the anti-lock brake system operation mode based on occurrence of wheel slip of the vehicle.

11. The brake system of claim 10, wherein the second controller is configured to identify occurrence of wheel slip of the vehicle, based on an output signal from a wheel speed sensor of the vehicle, while a force is applied to a brake pedal of the vehicle.

12. The brake system of claim 11, wherein the second controller is configured to identify that a force is applied to the brake pedal, according to reception of an output signal from a pedal sensor configured to detect a displacement of the brake pedal.

13. The brake system of claim 12, wherein the second controller is configured to control the first controller to provide current for driving torque to the motor by providing the first controller with a pressure force of the electro mechanical brake according to the output signal from the pedal sensor, while no wheel slip of the vehicle occurs.

14. A method for controlling a brake system, comprising:
detecting a signal for operating an anti-lock brake system of a vehicle; and
controlling an electro mechanical brake to provide current for reverse driving torque to a motor, based on a torque value of the motor at a time at which the motor starts being driven in a brake release direction, according to the signal for operating the anti-lock brake system.

15. The method of claim 14, further comprising:
storing a plurality of preset reference torque values at the time at which the motor starts being driven in the brake release direction and current values for target reverse driving torque respectively corresponding to the plurality of preset reference torque values;
identifying a reference torque value corresponding to the torque value of the motor at the time at which the motor starts being driven in the brake release direction from among the plurality of preset reference torque values; and
determining a current value for target reverse driving torque corresponding to the identified reference torque value as a current value of the current for reverse driving torque.

16. The method of claim 14, further comprising controlling the electro mechanical brake to stop providing the current for reverse driving torque to the motor, according to a speed of the motor reaching a preset target speed while the current for reverse driving torque is provided to the motor.

17. The method of claim 14, wherein the signal for operating the anti-lock brake system is generated based on occurrence of wheel slip of the vehicle.

18. The method of claim 17, further comprising identifying occurrence of wheel slip of the vehicle based on an output signal from a wheel speed sensor of the vehicle, while a force is applied to a brake pedal of the vehicle.

19. The method of claim 18, comprising identifying that a force is applied to the brake pedal according to reception of an output signal from a pedal sensor configured to detect a displacement of the brake pedal.

20. The method of claim 19, further controlling the electro mechanical brake to provide current for driving torque to the motor based on a braking force according to an output signal from the pedal sensor, while no wheel slip of the vehicle occurs.
